(19) United States
(12) Patent Application Publication
(10) Pub. No.: US 2024/0351938 A1
(43) Pub. Date: Oct. 24, 2024

(54) WATER REPELLENT GLASS MEMBER AND MANUFACTURING METHOD FOR SAME, LENS MEMBER, COVER MEMBER, AND WINDOW PANEL MEMBER

(71) Applicant: NIPPON ELECTRIC GLASS CO., LTD., Otsu-shi, Shiga (JP)

(72) Inventors: Takumi KINOSHITA, Otsu-shi (JP); Naoki FUJITA, Otsu-shi (JP)

(21) Appl. No.: 18/683,876

(22) PCT Filed: Aug. 19, 2022
(86) PCT No.: PCT/JP2022/031337

§ 371 Date: Feb. 15, 2024

(30) Foreign Application Priority Data
Aug. 23, 2021 (JP) 2021-135597

(51) Int. Cl. C03C 15/00; B24C 1/04; C03C 17/00; G02B 1/11; G02B 1/18

(52) U.S. Cl. CPC C03C 15/00; B24C 1/04; C03C 17/002; G02B 1/11; G02B 1/18; C03C 2217/732; C03C 2217/76

(57) ABSTRACT

Provided is a water-repellent glass member having excellent water repellency even without forming a water-repellent film on its surface. A water-repellent glass member 1 has a surface 1a with unevenness, wherein when a cutoff value of a high-pass filter λc in a 5 μm×5 μm area of the surface 1a with unevenness is 2.5 μm, a mean width RSm1 of roughness profile elements is not less than 70 nm and not more than 800 nm, and when a cutoff value of a low-pass filter λs in a 140 μm×105 μm area of the surface 1a with unevenness is 0.80 μm, a mean width RSm2 of roughness profile elements is not less than 3.0 μm and not more than 100.0 μm.

### TECHNICAL FIELD

The present invention relates to water-repellent glass members, manufacturing methods for the water-repellent glass members, and lens members, cover members, and window panel members in all of which the water-repellent glass members are used.

### BACKGROUND ART

Cameras for use outdoors, including vehicle-mounted cameras and monitoring cameras, are required to prevent water drops from adhering to the camera surfaces and thus provide clear images even in the rain. For this reason, lens members and cover members for these cameras are required to be highly water-repellent glass members.

Meanwhile, in motor vehicles, railway vehicles, ships, airplanes, and so on, use of highly water-repellent window panels enables their wiper and like mechanisms to be dispensed with. Thus, the number of parts can be reduced and the production process can be shortened, which promises a reduction in production cost. Therefore, in recent years, there have been increasing demands for highly water-repellent glasses.

Patent Literature 1 below discloses a water-repellent cleaning structure for a vehicle light front lens in which the surface of the front lens is coated with a fluorine-based or silicone-based resin.

### CITATION LIST

### Patent Literature

[PTL 1]
JP-A-H06-330363

### SUMMARY OF INVENTION

### Technical Problem

However, in many cases, when, as in Patent Literature 1, a film made of an organic fluorine compound or others is formed on the surface of a glass member, the formed film is very thin and, thus, may be worn or detached by friction due to rubbing or so on. Therefore, the film has a problem of difficulty maintaining high repellency over a long period of time.

An object of the present invention is to provide a water-repellent glass member having excellent water repellency even without forming a water-repellent film on its surface, a manufacturing method for the water-repellent glass member, and a lens member, a cover member, and a window panel member in all of which the water-repellent glass member is used.

### Solution to Problem

Aspects for solving the above problem will be described below.

A water-repellent glass member according to aspect 1 of the present invention is a water-repellent glass member having a surface with unevenness, wherein when a cutoff value of a high-pass filter λc in a 5 μm×5 μm area of the surface with unevenness is 2.5 μm, a mean width RSm1 of roughness profile elements is not less than 70 nm and not more than 800 nm, and when a cutoff value of a low-pass filter λs in a 140 μm×105 μm area of the surface with unevenness is 0.80 μm, a mean width RSm2 of roughness profile elements is not less than 3.0 μm and not more than 100.0 μm.

A water-repellent glass member according to aspect 2 of the present invention is the water-repellent glass member according to aspect 1, wherein when the cutoff value of the high-pass filter λc in the 5 μm×5 μm area of the surface with unevenness is 2.5 μm, an arithmetical mean height Sa1 is preferably not less than 1 nm and not more than 50 nm.

A water-repellent glass member according to aspect 3 of the present invention is the water-repellent glass member according to aspect 1 or 2, wherein when the cutoff value of the low-pass filter λs in the 140 μm×105 μm area of the surface with unevenness is 0.80 μm, an arithmetical mean height Sa2 is preferably not less than 1 nm and not more than 1500 nm.

A water-repellent glass member according to aspect 4 of the present invention is the water-repellent glass member according to any one of aspects 1 to 3, wherein when the cutoff value of the high-pass filter λc in the 5 μm×5 μm area of the surface with unevenness is 2.5 μm, a skewness Ssk is preferably −0.1 or less.

A water-repellent glass member according to aspect 5 of the present invention is the water-repellent glass member according to any one of aspects 1 to 4, wherein when the cutoff value of the high-pass filter λc in the 5 μm×5 μm area of the surface with unevenness is 2.5 μm, a ratio between a mean height Rc1 and the mean width RSm1 of roughness profile elements (Rc1/RSm1) is preferably not less than 0.02 and not more than 1.00.

A water-repellent glass member according to aspect 6 of the present invention is the water-repellent glass member according to any one of aspects 1 to 5, wherein a contact angle of water with the surface with unevenness of the water-repellent glass member is preferably 90° or greater.

A water-repellent glass member according to aspect 7 of the present invention is the water-repellent glass member according to any one of aspects 1 to 6, wherein the water-repellent glass member may include a glass member body and a water-repellent film provided on a principal surface of the glass member body.

A water-repellent glass member according to aspect 8 of the present invention is the water-repellent glass member according to any one of aspects 1 to 7, wherein the water-repellent glass member may include a glass member body and an optically functional film provided on a principal surface of the glass member body.

A water-repellent glass member according to aspect 9 of the present invention is the water-repellent glass member according to aspect 8, wherein the optically functional film is preferably an antireflection film or a reflective film.

A method for manufacturing a water-repellent glass member according to the present invention is a method for manufacturing the water-repellent glass member configured according to any one of aspects 1 to 9 and includes the steps of: subjecting a surface of the glass member to chemical etching processing; and subjecting the surface of the glass member, after being subjected to the chemical etching processing, to wet blasting processing.

A lens member according to aspect 11 of the present invention includes the water-repellent glass member configured according to any one of aspects 1 to 9.

A cover member according to aspect 12 of the present invention includes the water-repellent glass member configured according to any one of aspects 1 to 9.

A window panel member according to aspect 13 of the present invention includes the water-repellent glass member configured according to any one of aspects 1 to 9.

### Advantageous Effects of Invention

The present invention enables provision of a water-repellent glass member having excellent water repellency even without forming a water-repellent film on its surface, a manufacturing method for the water-repellent glass member, and a lens member, a cover member, and a window panel member in all of which the water-repellent glass member is used.

### BRIEF DESCRIPTION OF DRAWINGS

FIG. 1 is a schematic cross-sectional view showing a water-repellent glass member according to a first embodiment of the present invention.

FIG. 2 is a graph showing a roughness curve in a relatively small area of a first principal surface of the water-repellent glass member according to the first embodiment of the present invention.

FIG. 3 is a graph showing a roughness curve in a relatively large area of the first principal surface of the water-repellent glass member according to the first embodiment of the present invention.

FIG. 4 is a schematic cross-sectional view showing a water-repellent glass member according to a second embodiment of the present invention.

FIG. 5 is a photograph taken when a water drop was placed on a surface of a water-repellent glass member obtained in Example 4.

FIG. 6 is a photograph taken when a water drop was placed on a surface of a glass member obtained in Comparative Example 2.

FIG. 7 is a photograph taken when a water drop was placed on a surface of a glass member obtained in Comparative Example 4.

### DESCRIPTION OF EMBODIMENTS

Hereinafter, a description will be given of preferred embodiments. However, the following embodiments are merely illustrative and the present invention is not limited to the following embodiments. Throughout the drawings, members having substantially the same functions may be referred to by the same reference characters.

### First Embodiment

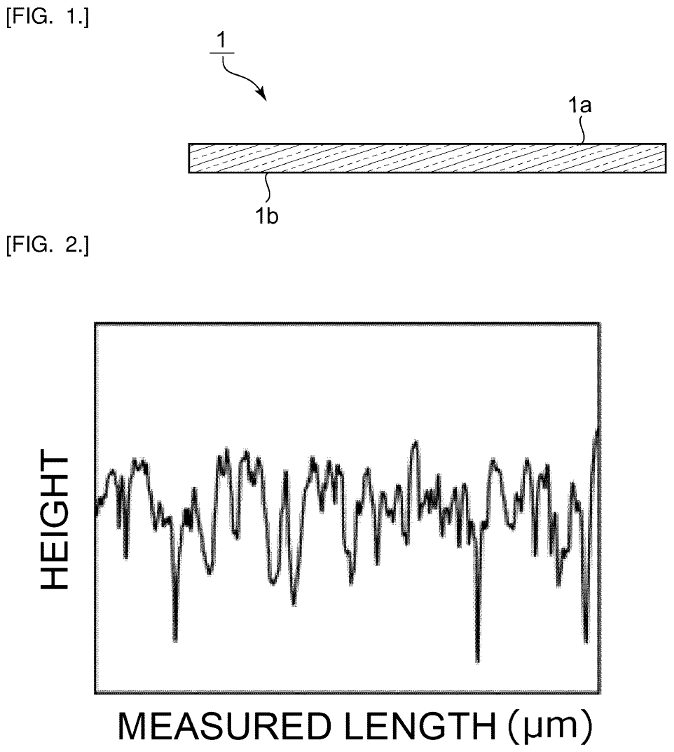

FIG. 1 is a schematic cross-sectional view showing a water-repellent glass member according to a first embodiment of the present invention.

As shown in FIG. 1, a water-repellent glass member 1 (hereinafter, the “water-repellent glass member 1” is also referred to simply as the “glass member 1”) has the shape of a rectangular flat plate. However, the shape of the glass member 1 is not particularly limited and may be a flat plate shape of a circular or polygonal profile, a shape in which a flat plate shape is entirely curved, a spherical or aspherical lens shape or so on.

The material of the glass member 1 is not particularly limited and examples include quartz glass, soda-lime glass, alkali-free glass, aluminosilicate glass, borosilicate glass, fluoride glass, and chalcogenide glass. These materials may be used singly or in a combination of a plurality of them.

The thickness of the glass member 1 is not particularly limited and, for example, may be not less than 50 μm and not more than 100 mm.

The glass member 1 has a first principal surface 1a and a second principal surface 1b opposed to each other. The first principal surface 1a and the second principal surface 1b are surfaces of the glass member 1. In this embodiment, unevenness is formed over the whole of the first principal surface 1a of the glass member 1.

In the present invention, it is sufficient that unevenness is formed on at least a portion of the first principal surface 1a of the glass member 1. The unevenness is preferably provided on 1% or more, more preferably 30% or more, and still more preferably 50% or more of the first principal surface 1a of the glass member 1. As in this embodiment, the unevenness may be provided over the whole of the first principal surface 1a of the glass member 1. Alternatively, the unevenness may be provided on the second principal surface 1b of the glass member 1.

In this embodiment, when the cutoff value of a high-pass filter λc in a 5 μm×5 μm area of the first principal surface 1a of the glass member 1 is 2.5 μm, the mean width RSm1 of roughness profile elements is not less than 70 nm and not more than 800 nm. Furthermore, when the cutoff value of a low-pass filter λs in a 140 μm×105 μm area of the first principal surface 1a of the glass member 1 is 0.80 μm, the mean width RSm2 of roughness profile elements is not less than 3.0 μm and not more than 100.0 μm. The mean width RSm of roughness profile elements can be measured in conformity with JIS B 0601:2013.

Since the glass member 1 according to this embodiment has the above structure, it has excellent water repellency even without any water-repellent film being formed on the surface.

It is heretofore known that when unevenness is formed on the surface of a solid, the tendency of wettability of the solid surface with water varies widely depending on whether the solid is hydrophilic or water-repellent.

Specifically, the Wenzel model explains that hydrophilic solids are further increased in hydrophilicity by the formation of unevenness on the solid surfaces, whereas water-repellent solids are further increased in water repellency by the formation of unevenness on the solid surfaces.

In this relation, the surface of the glass member is hydrophilic. Therefore, if unevenness is formed on its surface, its hydrophilicity will be further increased.

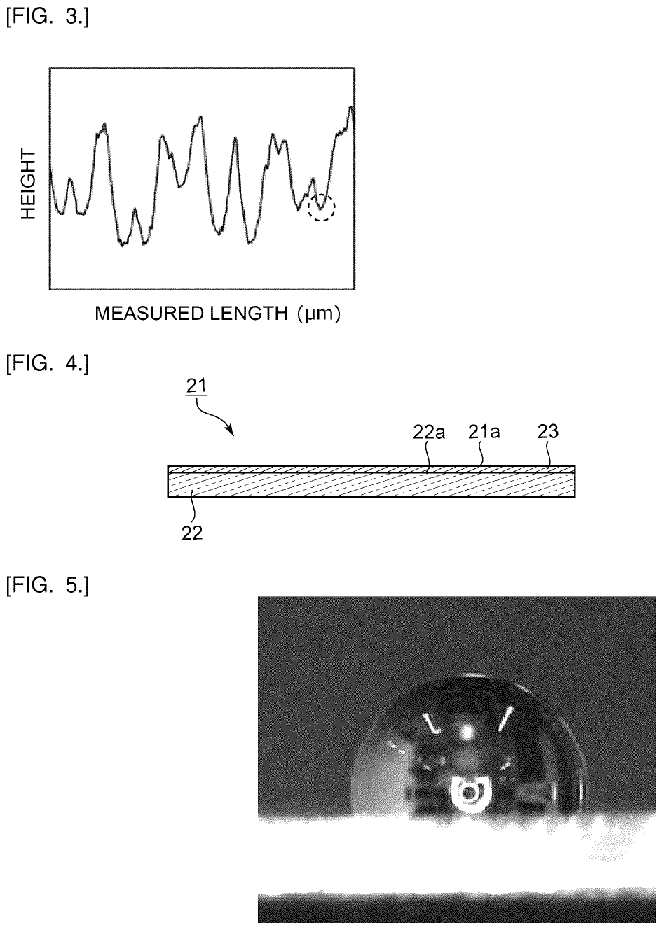

In these conditions, the inventors focused on both a roughness curve in a relatively small area of the first principal surface 1a (the surface) of the glass member 1 and a roughness curve in a relatively large area of the first principal surface 1a (the surface) of the glass member 1. The roughness curve in a relatively small area of the first principal surface 1a (the surface) of the glass member 1 is represented, for example, as a roughness curve as shown in FIG. 2. On the other hand, the roughness curve in a relatively large area of the first principal surface 1a (the surface) of the glass member 1 is represented, for example, as a roughness curve as shown in FIG. 3. The roughness curves in FIGS. 2 and 3 are schematic roughness curves given for illustration and the portion enclosed by the broken line in FIG. 3 corresponds to the roughness curve in FIG. 2.

Specifically, the inventors found that, surprisingly, when the mean width RSm1 of roughness profile elements in a relatively small area (a 5 μm×5 μm area) of the first principal surface 1a (hereinafter, also referred to as the surface) of the glass member 1 and the mean width RSm2 of roughness profile elements in a relatively large area (a 140 μm×105 μm area) of the first principal surface 1a of the glass member 1 are adjusted within respective specific ranges, the water repellency of the surface of the glass member 1 can be increased.

The reason for the above can be understood as follows. It can be thought that when the above parameter RSm1 in the surface of the glass member 1 is not less than 70 nm and not more than 800 nm, an air layer is held in the depressions of the unevenness on the surface of the glass member 1, thus decreasing the wettability of the surface. In addition, it can be thought that when the above parameter RSm2 in the surface of the glass member 1 is not less than 3.0 μm and not more than 100.0 μm, a larger amount of air layer is held in the depressions of the unevenness on the surface of the glass member 1, thus further decreasing the wettability of the surface. It can be thought that, as these results, the water repellency of the surface of the glass member 1 can be increased.

In the present invention, the parameter RSm1 in the surface of the glass member 1 is preferably not less than 80 nm, more preferably not less than 90 nm, further more preferably not less than 100 nm, particularly preferably not less than 110 nm, most preferably not less than 120 nm, preferably not more than 700 nm, more preferably not more than 600 nm, further more preferably not more than 500 nm, particularly preferably not more than 400 nm, and most preferably not more than 350 nm.

When the parameter RSm1 in the surface of the glass member 1 is not less than the above lower limit, an air layer can be more certainly held in the depressions of the unevenness on the surface of the glass member 1, thus further increasing the water repellency. In addition, when the parameter RSm1 in the surface of the glass member 1 is not more than the above upper limit, liquid can be even less likely to enter the depressions of the unevenness on the surface of the glass member 1, thus even more certainly holding the air layer in the depressions. Therefore, the water repellency can be even further increased.

In the present invention, the above parameter RSm2 in the surface of the glass member 1 is preferably not less than 3.2 μm, more preferably not less than 3.4 μm, further more preferably not less than 3.6 μm, particularly preferably not less than 3.8 μm, most preferably not less than 4.0 μm, preferably not more than 90.0 μm, more preferably not more than 80.0 μm, further more preferably not more than 70.0 μm, even further more preferably not more than 60.0 μm, yet even furthermore preferably not more than 50.0 μm, still further more preferably not more than 40.0 μm, and yet still further more preferably not more than 30.0 μm.

When the parameter RSm2 in the surface of the glass member 1 is not less than the above lower limit, its difference from the parameter RSm1 can be further increased and, thus, a larger amount of air layer can be held in the depressions of the unevenness on the surface of the glass member 1. Therefore, the water repellency can be even further increased. In addition, when the parameter RSm2 in the surface of the glass member 1 is not more than the above upper limit, liquid can be even less likely to enter the depressions of the unevenness on the surface of the glass member 1, thus even more certainly holding the air layer in the depressions. Therefore, the water repellency can be even further increased.

In the present invention, when the cutoff value of a high-pass filter λc in a 5 μm×5 μm area of the first principal surface 1a of the glass member 1 is 2.5 μm, the arithmetical mean height Sa1 is preferably not less than 1 nm, more preferably not less than 2 nm, further more preferably not less than 3 nm, even further more preferably not less than 4 nm, yet even further more preferably not less than 5 nm, preferably not more than 50 nm, more preferably not more than 40 nm, further more preferably not more than 30 nm, particularly preferably not more than 20 nm, and most preferably not more than 15 nm. The arithmetical mean height Sa (Sa1) can be measured in conformity with ISO 25178.

When the arithmetical mean height Sa1 in the surface of the glass member 1 is not less than the above lower limit, liquid can be even less likely to enter the depressions of the unevenness on the surface of the glass member 1, thus even more certainly holding the air layer in the depressions. Therefore, the water repellency can be further increased. In addition, when the arithmetical mean height Sa1 in the surface of the glass member 1 is not more than the above upper limit, light scattering due to the shape of unevenness can be even less likely to occur and, thus, the clearness of the surface of the glass member 1 can be even less likely to be impaired. From the viewpoint of further increasing the water repellency, when the cutoff value of a high-pass filter λc in a 5 μm×5 μm area of the first principal surface 1a of the glass member 1 is 2.5 μm, the arithmetical mean height Sa1 may be, for example, not less than 10 nm, not less than 15 nm, not less than 20 nm, not less than 25 nm, not less than 30 nm, not less than 31 nm, not less than 33 nm, not less than 35 nm, not less than 38 nm, not less than 40 nm, not less than 43 nm or not less than 45 nm.

Therefore, when the arithmetical mean height Sa1 in the surface of the glass member 1 is within the above range, the water repellency of the surface of the glass member 1 can be further increased and the clearness of the surface of the glass member 1 can be even less likely to be impaired.

In the present invention, when the cutoff value of a low-pass filter λs in a 140 μm×105 μm area of the first principal surface 1a of the glass member 1 is 0.80 μm, the arithmetical mean height Sa2 is preferably not less than 1 nm, more preferably not less than 3 nm, further more preferably not less than 5 nm, particularly preferably not less than 7 nm, most preferably not less than 10 nm, preferably not more than 1500 nm, more preferably not more than 1200 nm, further more preferably not more than 1000 nm, even further more preferably not more than 800 nm, yet even further more preferably not more than 600 nm, still further more preferably not more than 500 nm, yet still further more preferably not more than 400 nm, yet still further more preferably not more than 300 nm, particularly preferably not more than 200 nm, and most preferably not more than 100 nm. The arithmetical mean height Sa (Sa2) can be measured in conformity with ISO 25178.

When the arithmetical mean height Sa2 in the surface of the glass member 1 is not less than the above lower limit, liquid can be even less likely to enter the depressions of the unevenness on the surface of the glass member 1, thus even more certainly holding the air layer in the depressions. Therefore, the water repellency can be further increased. In addition, when the arithmetical mean height Sa2 in the surface of the glass member 1 is not more than the above upper limit, light scattering due to the shape of unevenness can be even less likely to occur and, thus, the clearness of the surface of the glass member 1 can be even less likely to be impaired.

Therefore, when the arithmetical mean height Sa2 in the surface of the glass member 1 is within the above range, the water repellency of the surface of the glass member 1 can be further increased and the clearness of the surface of the glass member 1 can be even less likely to be impaired.

In the present invention, when the cutoff value of a high-pass filter λc in a 5 μm×5 μm area of the first principal surface 1a of the glass member 1 is 2.5 μm, the skewness Ssk is preferably −0.1 or less, more preferably −0.2 or less, and further more preferably −0.3 or less. The skewness Ssk can be measured in conformity with ISO 25178.

When the skewness Ssk in the surface of the glass member 1 is the above upper limit or less, the histogram of heights of the shape of unevenness is distributed more heavily toward upper side and, therefore, a steeper shape of unevenness having deep depressions relative to projections is formed. As a result, the air layer held in the depressions can be less likely to be displaced by liquid and can be more easily held therein, and, thus, the water repellency of the surface of the glass member 1 can be further increased.

The lower limit of the skewness Ssk in the first principal surface 1a of the glass member 1 is not particularly limited, but, may be, for example, −10.0.

In the present invention, when the cutoff value of a high-pass filter λc in a 5 μm×5 μm area of the first principal surface 1a of the glass member 1 is 2.5 μm, the ratio between the mean height Rc1 and mean width RSm1 of roughness profile elements (Rc1/RSm1) is preferably not less than 0.02, more preferably not less than 0.03, further more preferably not less than 0.04, particularly preferably not less than 0.05, most preferably not less than 0.07, preferably not more than 1.00, more preferably not more than 0.70, further more preferably not more than 0.50, particularly preferably not more than 0.30, and most preferably not more than 0.20. The ratio between the mean height Rc1 and mean width RSm1 of roughness profile elements (Rc1/RSm1) can be measured in conformity with JIS B 0601:2013.

When the above ratio (Rc1/RSm1) in the surface of the glass member 1 is not less than the above lower limit, liquid can be even less likely to enter the depressions of the unevenness on the surface of the glass member 1, thus even more certainly holding the air layer in the depressions. Therefore, the water repellency can be further increased. In addition, when the above ratio (Rc1/RSm1) in the surface of the glass member 1 is not more than the above upper limit, light scattering due to the shape of unevenness is even less likely to occur and, thus, the clearness of the surface of the glass member 1 can be even less likely to be impaired. Furthermore, the surface of the glass member 1 can be even less susceptible to damages due to wear or other causes and the durability of the unevenness can be thus further increased.

Therefore, when the ratio (Rc1/RSm1) in the first principal surface 1a of the glass member 1 is within the above range, the water repellency of the surface of the glass member 1 can be further increased and the clearness of the surface of the glass member 1 can be even less likely to be impaired. Furthermore, the surface of the glass member 1 can be even less susceptible to damages due to wear or other causes and the durability of the unevenness can be thus further increased.

As thus far described, the unevenness formed on the surface of the glass member 1 can be expressed by parameters related to various roughness curves defined by JIS B 0601:2013 (such as the mean width RSm of elements and the ratio between the mean height Rc1 of elements and the mean width RSm of elements (Rc/RSm)) and parameters related to various surface roughnesses defined by ISO 25178 (such as arithmetical mean height Sa and skewness Ssk).

In addition, in the present invention, it is sufficient that at least the above parameter RSm1 is not less than 70 nm and not more than 800 nm and the above parameter RSm2 is not less than 3.0 μm and not more than 100.0 μm, and the other parameters (the arithmetical mean height Sa1, the arithmetical mean height Sa2, the skewness Ssk, and the ratio between the mean height Rc1 of elements and the mean width RSm1 of elements (Rc1/RSm1)) need not necessarily be met.

Note that the term “water-repellent” herein means that the contact angle represented by, of both the angles formed between the tangent to a liquid surface and a solid surface, the angle including the liquid is 90° or greater.

Specifically, the contact angle of water with the surface of the glass member 1 is 90 or greater, preferably 93° or greater, more preferably 95° or greater, further more preferably 97° or greater, and particularly preferably 100° or greater. In this case, the water repellency of the surface of the glass member 1 can be further increased. The upper limit of the contact angle of water with the surface of the glass member 1 is not particularly limited and may be, for example, 180°.

The contact angle (θ) on the surface of the glass member 1 can be measured based on the sessile drop method (half-angle fitting method) defined in JIS R3257:1999. For example, in this embodiment, the contact angle can be measured by placing the glass member 1 horizontally with the first principal surface 1a facing up, putting a drop of 2 μL of pure water on the first principal surface 1a, and taking a photograph of the water drop edge-on with a digital scope (product name: “VHX-500F” manufactured by Keyence Corporation).

In the present invention, the haze of the glass member 1 can be arbitrarily selected depending on desired properties or purposes. For example, when the clearness should be more certainly ensured, the haze of the glass member 1 is preferably less than 90%, more preferably 80% or less, further more preferably 70% or less, even further more preferably 60% or less, yet even further more preferably 50% or less, still further more preferably 40% or less, yet still further more preferably 30% or less, and yet still further more preferably 20% or less. On the other hand, from the viewpoint of more certainly suppressing reflection, the haze of the glass member 1 is preferably 3% or more, more preferably 5% or more, further more preferably 10% or more, even further more preferably 15% or more, yet even further more preferably 20% or more, still further more preferably 25% or more, yet still further more preferably 30% or more, and yet still further more preferably 35% or more.

Since the glass member 1 according to this embodiment has excellent water repellency, it can be suitably used as lens members and cover members of cameras for use outdoors, including vehicle-mounted cameras and monitoring cameras. In addition, the glass member 1 according to this embodiment can also be suitably used as window panel members of motor vehicles, railway vehicles, ships, airplanes, and so on.

### (Manufacturing Method)

Next, a description will be given of an example of the method for manufacturing the glass member 1.

Unevenness on the first principal surface 1a of the glass member 1 is formed by subjecting a surface of a glass member to chemical etching processing and then subjecting it to wet blasting processing.

The chemical etching processing is processing of immersion of the glass member into a chemical, such as hydrofluoric acid, to form unevenness thereon. Prior to the formation of unevenness by immersing the glass member into a chemical, such as hydrofluoric acid, the glass member may be subjected to wet blasting processing or the like to give the glass member unevenness serving as initiation sites of etching.

The wet blasting processing is processing of high-speed spraying of a slurry obtained by homogeneously stirring abrasive particles composed of alumina particles or other solid particles and water or other liquids onto a workpiece formed of a glass member from a spray nozzle using compressed air to form fine unevenness on the workpiece.

In the wet blasting processing, when the slurry sprayed at high speed impinges on the workpiece, the abrasive particles in the slurry grind, strike, and scrape the surface of the workpiece, so that fine unevenness is formed on the surface of the workpiece.

In this case, the abrasive particles shot onto the workpiece and fragments of the workpiece ground by the abrasive particles are flushed out with the liquid sprayed onto the workpiece and, therefore, the amount of particles remaining on the workpiece is small.

By the chemical etching processing, the above-described parameters RSm2 and Sa2 in the surface of the resulting glass member 1 can be adjusted. The parameters RSm2 and Sa2 in the surface of the glass member 1 can be adjusted also by the average particle diameter of abrasive particles in the wet blasting processing for giving the surface unevenness mainly serving as initiation sites of etching, the air pressure during spraying of the slurry containing abrasive particles, the scanning speed of the nozzle in the wet blasting processing, the composition of the chemical for use in the chemical etching processing and the processing time of the chemical etching processing, and so on.

In the wet blasting processing for giving unevenness serving as initiation sites of etching (hereinafter, referred to as the first wet blasting processing), the average particle diameter of the abrasive particles may be, for example, not less than 0.2 μm and not more than 60 μm. The average particle diameter of the abrasive particles can be measured, for example, by the electrical resistance method.

In the first wet blasting processing, the air pressure during spraying of the slurry containing abrasive particles is, for example, preferably not less than 0.1 MPa and not more than 0.5 MPa.

In the first wet blasting processing, the scanning speed of the nozzle in the wet blasting processing is, for example, preferably not less than 0.1 mm/s and not more than 100 mm/s.

In the chemical etching processing, the composition of the chemical may be, for example, hydrofluoric acid, a mixture solution containing hydrofluoric acid, a mixture solution containing hydrofluoric acid and sulfuric acid, a mixture solution containing hydrofluoric acid and nitric acid, or a mixture solution containing hydrofluoric acid and hydrochloric acid. Citric acid, ethylenediamine tetraacetic acid or others may be further added as a chelating agent to the chemical.

In the chemical etching processing, the processing time is, for example, preferably not shorter than 1 second and not longer than three hours.

Furthermore, by the wet blasting processing (hereinafter, referred to as second wet blasting processing) after the chemical etching processing, the above-described parameters RSm1, Sa1, and Ssk and the above-described ratio (Rc1/RSm1) in the surface of the resulting glass member 1 can be adjusted. The parameters RSm1, Sa1, and Ssk and the ratio (Rc1/RSm1) in the surface of the glass member 1 can be adjusted by the average particle diameter of the abrasive particles in the second wet blasting processing, the air pressure during spraying of the slurry containing abrasive particles, the scanning speed of the nozzle in the second wet blasting processing, and so on.

In the second wet blasting processing, the average particle diameter of the abrasive particles is, for example, preferably not less than 0.2 μm and not more than 60 μm.

In the second wet blasting processing, the air pressure during spraying of the slurry containing abrasive particles is, for example, preferably not less than 0.1 MPa and not more than 0.5 MPa.

In the second wet blasting processing, the scanning speed of the nozzle in the wet blasting processing is, for example, preferably not less than 0.1 mm/s and not more than 100 mm/s.

In the case of the wet blasting processing, the liquid carries the abrasive particles to the workpiece upon spraying of the slurry onto the workpiece. Therefore, as compared to dry sandblasting processing, fine abrasive particles can be easily used and the shock at the time of impingement of the abrasive particles on the workpiece is small, which enables the workpiece to be precisely processed.

By subjecting the workpiece (the glass member) to the chemical etching processing and the wet blasting processing in the above manners, the shape of unevenness with appropriate sizes can be formed on the surface of the glass member 1. Thus, the water repellency of the surface of the glass member 1 can be increased without impairing the clearness of the glass member 1.

### Second Embodiment

FIG. 4 is a schematic cross-sectional view showing a water-repellent glass member according to a second embodiment of the present invention. As shown in FIG. 4, a water-repellent glass member 21 (hereinafter, the “water-repellent glass member 21” is also referred to simply as the “glass member 21”) includes a glass member body 22 and a functional film 23. The functional film 23 is provided on a principal surface 22a of the glass member body 22.

In this embodiment, similar unevenness to those on the principal surface 1a of the glass member 1 according to the first embodiment is formed on a principal surface 21a of the glass member 21 (i.e., a principal surface of the functional film 23). As just described, in the case of forming the functional film 23 on the principal surface 22a of the glass member body 22, the shape of unevenness may be previously formed on the principal surface 22a of the glass member body 22 so that the shape of unevenness on the principal surface of the formed functional film 23 (the principal surface 21a) has a similar shape of unevenness to that on the principal surface 1a of the glass member 1 according to the first embodiment. Alternatively, the unevenness may be formed after the formation of the functional film 23.

For example, a water-repellent film can be used as the functional film 23. An organic thin film or like films for increasing the water repellency can be used as the water-repellent film. The materials for the organic thin film that can be used include silane compounds containing an alkyl group or a fluoroalkyl group. Specifically, the organic thin film can be formed (deposition) by binding a silane compound containing an alkyl group or a fluoroalkyl group or the like to the surface of the glass member.

Alternatively, the functional film 23 may be an optically functional film. For example, an antireflection film or a reflective film can be used as the optically functional film. Examples that can be used as the antireflection film and the reflective film include a low-refractive index film having a lower refractive index than the glass member body 22 and a dielectric multi-layer film in which low-refractive index films having a relatively low refractive index and high-refractive index films having a relatively high refractive index are alternately layered. The antireflection film and the reflective film can be formed by sputtering, CVD or other methods.

The rest is the same as in the first embodiment.

Also as to the glass member 21, when the cutoff value of a high-pass filter λc in a 5 μm×5 μm area of the principal surface 21a of the glass member 21 is 2.5 μm, the mean width RSm1 of roughness profile elements is not less than 70 nm and not more than 800 nm. Furthermore, when the cutoff value of a low-pass filter λs in a 140 μm×105 μm area of the principal surface 21a of the glass member 21 is 0.80 μm, the mean width RSm2 of roughness profile elements is not less than 3.0 μm and not more than 100.0 μm.

Since the glass member 21 according to this embodiment has the above structure, it has excellent water repellency even without any water-repellent film being formed on the surface.

The thickness of the functional film 23 is not particularly limited without impairing the above effects of the invention, but may be, for example, not less than 1 nm and not more than 50 μm.

Hereinafter, a description will be given in further detail of the present invention with reference to specific examples. The present invention is not at all limited by the following examples and modifications and variations may be appropriately made therein without changing the gist of the invention.

### Examples 1 to 26

First, a 0.5 mm thick sheet of aluminosilicate glass (product name: “T2X-1” manufactured by Nippon Electric Glass Co., Ltd.) having the shape of a rectangular plate was prepared.

In Examples 1 to 26, one of the principal surfaces of the prepared sheet of aluminosilicate glass (hereinafter, also referred to simply as the glass) was entirely subjected to the wet blasting processing (the first wet blasting processing) to give the principal surface unevenness serving as initiation sites of chemical etching and then subjected to the chemical etching processing. Next, the glass subjected to the chemical etching processing was subjected to the wet blasting processing (the second wet blasting processing), thus producing a water-repellent glass member.

Specifically, in the first wet blasting processing, a slurry was first prepared by using abrasive particles made of alumina and having an average particle diameter of 1.2 μm, 3.0 μm, 6.9 μm, 14.7 μm or 41.1 μm and homogeneously stirring the abrasive particles with water. Next, the whole of one principal surface of each glass was subjected to the wet blasting processing by scanning the principal surface with a nozzle while moving the nozzle at a processing speed of 5 mm/s to 50 mm/s and spraying the prepared slurry from the nozzle onto the principal surface at a processing air pressure of 0.10 MPa to 0.32 MPa.

In the chemical etching processing, the glass was subjected to the chemical etching processing by using an etching liquid prepared to have a content of hydrofluoric acid of 2% by mass to 5% by mass, a content of sulfuric acid of 0% by mass to 50% by mass, and a content of water of 48% by mass to 98% by mass and immersing the glass into the etching liquid at a liquid temperature of 30° C. for a processing time of 30 seconds to 30 minutes (0.5 minutes to 30.0 minutes).

In the second wet blasting processing, a slurry was first prepared by using abrasive particles made of alumina and having an average particle diameter of 1.2 μm or 4.0 μm and homogeneously stirring the abrasive particles with water. Next, the whole of the one principal surface of each glass was subjected to the wet blasting processing by spraying the prepared slurry onto the whole one principal surface. The spraying of the slurry was conducted by scanning the principal surface with the nozzle while moving the nozzle at a processing speed of 10 mm/s and spraying the prepared slurry from the nozzle at a processing air pressure of 0.1 MPa to 0.3 MPa. In the above manner, a glass member with unevenness was produced.

The conditions for production of the glass members in Examples 1 to 26 are shown in Tables 1 and 2 below.

TABLE 1

| | | | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 | Ex. 14 |
|---|---|---|---|---|---|---|---|---|---|---|---|---|---|---|---|---|
| First Wet | Average | [μm] | 3.0 | 3.0 | 1.2 | 3.0 | 6.9 | 3.0 | 3.0 | 6.9 | 3.0 | 6.9 | 6.9 | 3.0 | 6.9 | 6.9 |
| Blasting | particle | | | | | | | | | | | | | | | |
| Processing | diameter | | | | | | | | | | | | | | | |
| | Scanning | [mm/s] | 10 | 10 | 10 | 10 | 10 | 5 | 5 | 5 | 10 | 10 | 5 | 5 | 10 | 10 |
| | speed | | | | | | | | | | | | | | | |
| | Air pressure | [MPa] | 0.15 | 0.15 | 0.15 | 0.15 | 0.25 | 0.25 | 0.15 | 0.15 | 0.15 | 0.25 | 0.15 | 0.25 | 0.25 | 0.25 |
| Chemical | Hydrofluoric | [% by | 5 | 2 | 2 | 2 | 2 | 2 | 5 | 2 | 2 | 2 | 2 | 5 | 2 | 2 |
| Etching | acid | mass] | | | | | | | | | | | | | | |
| Processing | Sulfuric | [% by | 0 | 40 | 40 | 45 | 50 | 50 | 0 | 30 | 30 | 40 | 30 | 0 | 50 | 50 |
| | acid | mass] | | | | | | | | | | | | | | |
| | Processing | [min.] | 5.0 | 20.0 | 20.0 | 30.0 | 30.0 | 10.0 | 0.5 | 10.0 | 20.0 | 30.0 | 30.0 | 10.0 | 30.0 | 30.0 |
| | time | | | | | | | | | | | | | | | |
| Second | Average | [μm] | 1.2 | 1.2 | 1.2 | 1.2 | 1.2 | 1.2 | 1.2 | 1.2 | 1.2 | 1.2 | 1.2 | 1.2 | 1.2 | 1.2 |
| Wet | particle | | | | | | | | | | | | | | | |
| Blasting | diameter | | | | | | | | | | | | | | | |
| Processing | Scanning | [mm/s] | 10 | 10 | 10 | 10 | 10 | 10 | 10 | 10 | 10 | 10 | 10 | 10 | 10 | 10 |
| | speed | | | | | | | | | | | | | | | |
| | Air pressure | [MPa] | 0.2 | 0.2 | 0.2 | 0.2 | 0.2 | 0.2 | 0.2 | 0.2 | 0.2 | 0.2 | 0.2 | 0.2 | 0.1 | 0.3 |

TABLE 2

| | | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | | 15 | 16 | 17 | 18 | 19 | 20 | 21 | 22 | 23 | 24 | 25 | 26 |
| First Wet | Average | [μm] | 1.2 | 1.2 | 1.2 | 6.9 | 6.9 | 6.9 | 14.7 | 14.7 | 41.1 | 41.1 | 41.1 | 6.9 |
| Blasting | particle | | | | | | | | | | | | | |
| Processing | diameter | | | | | | | | | | | | | |
| | Scanning | [mm/s] | 50 | 50 | 50 | 10 | 10 | 10 | 5 | 5 | 5 | 5 | 5 | 10 |
| | speed | | | | | | | | | | | | | |
| | Air pressure | [MPa] | 0.32 | 0.32 | 0.32 | 0.15 | 0.15 | 0.15 | 0.10 | 0.20 | 0.20 | 0.20 | 0.20 | 0.15 |
| Chemical | Hydroftuoric | [% by | 2 | 2 | 2 | 2 | 2 | 2 | 2 | 2 | 2 | 2 | 2 | 2 |
| Etching | acid | mass] | | | | | | | | | | | | |
| Processing | Sulfuric | [% by | 50 | 40 | 0 | 40 | 35 | 30 | 0 | 0 | 50 | 40 | 20 | 30 |
| | acid | mass] | | | | | | | | | | | | |
| | Processing | [min.] | 13.0 | 10.0 | 10.0 | 30.0 | 30.0 | 20.0 | 30.0 | 10.0 | 28.0 | 30.0 | 25.0 | 20.0 |
| | time | | | | | | | | | | | | | |
| Second Wet | Average | [μm] | 1.2 | 1.2 | 1.2 | 1.2 | 1.2 | 1.2 | 1.2 | 1.2 | 1.2 | 1.2 | 1.2 | 4.0 |
| Blasting | particle | | | | | | | | | | | | | |
| Processing | diameter | | | | | | | | | | | | | |
| | Scanning speed | [mm/s] | 10 | 10 | 10 | 10 | 10 | 10 | 10 | 10 | 10 | 10 | 10 | 10 |
| | Air pressure | [MPa] | 0.3 | 0.3 | 0.3 | 0.3 | 0.3 | 0.3 | 0.3 | 0.3 | 0.3 | 0.3 | 0.3 | 0.3 |

### Comparative Example 1

In Comparative Example 1, a sheet of aluminosilicate glass of the same type as in Example 1 was used as it was without being subjected to the above series of processing.

### Comparative Example 2

In Comparative Example 2, the glass was subjected to the chemical etching processing in the same manner as in Example 4, but not subjected to the second wet blasting processing. The rest was conducted in the same manner as in Example 4, thus obtaining a glass member.

### Comparative Example 3

In Comparative Example 3, the glass was subjected to the chemical etching processing in the same manner as in Example 5, but not subjected to the second wet blasting processing. The rest was conducted in the same manner as in Example 5, thus obtaining a glass member.

### Comparative Example 4

In Comparative Example 4, the whole of one principal surface of a sheet of glass of the same type as in Example 1 was subjected to the wet blasting processing, thus obtaining a glass member. Therefore, in Comparative Example 4, the glass was not subjected to the chemical etching processing.

In the wet blasting processing, a slurry was first prepared by using abrasive particles made of alumina and having an average particle diameter of 1.2 μm and homogeneously stirring the abrasive particles with water. Next, the whole of the one principal surface of the glass was subjected to the wet blasting processing by spraying the prepared slurry onto the whole one principal surface. The spraying of the slurry was conducted by scanning the principal surface with a nozzle while moving the nozzle at a processing speed of 10 mm/s and spraying the prepared slurry from the nozzle at a processing air pressure of 0.2 MPa.

### Comparative Example 5

In Comparative Example 5, the whole of one principal surface of a sheet of glass of the same type as in Example 1 was subjected to the wet blasting processing, thus obtaining a glass member. Therefore, in Comparative Example 5, the glass was not subjected to the chemical etching processing.

In the wet blasting processing, a slurry was first prepared by using abrasive particles made of alumina and having an average particle diameter of 1.2 μm and homogeneously stirring the abrasive particles with water. Next, the whole of the one principal surface of the glass was subjected to the wet blasting processing by spraying the prepared slurry onto the whole one principal surface. The spraying of the slurry was conducted by scanning the principal surface with a 1 mm diameter circular nozzle while moving the nozzle at a processing speed of 10 mm/s and 500 μm intervals and spraying the prepared slurry from the nozzle at a processing air pressure of 0.2 MPa. Thus, a surface having a parameter RSm2 of 500.0 μm was produced.

### (Evaluations)

### [Measurement of Contact Angle θ]

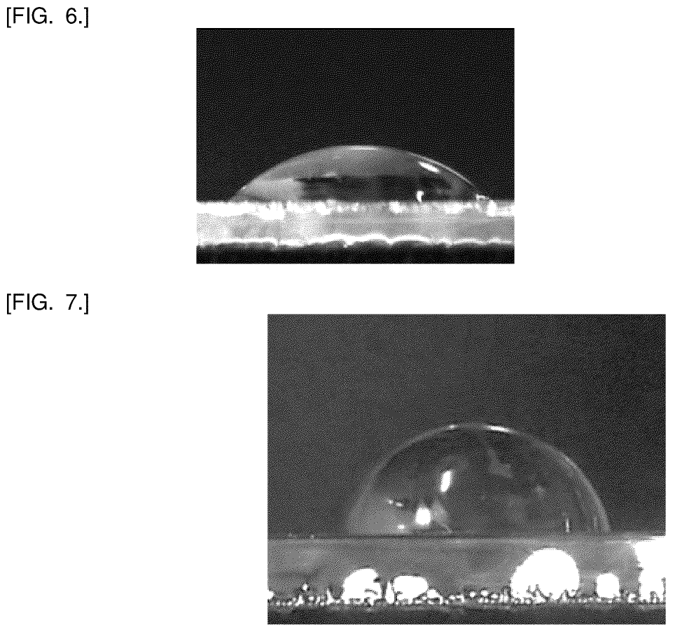

FIG. 5 is a photograph taken when a water drop was placed on a surface of the water-repellent glass member obtained in Example 4. FIG. 6 is a photograph taken when a water drop was placed on a surface of the glass member obtained in Comparative Example 2 and FIG. 7 is a photograph taken when a water drop was placed on a surface of the glass member obtained in Comparative Example 4.

As shown in FIG. 5, it can be seen that the water-repellent glass member obtained in Example 4 has a high water repellency (contact angle θ: 100°). On the other hand, as shown in FIGS. 6 and 7, the glass members obtained in Comparative Examples 2 and 4 showed insufficient water repellencies (contact angle θ in Comparative Example 2: 47°, contact angle θ in Comparative Example 4: 80°).

Next, the water-repellent glass members in Examples 1 to 26 and the glass members in Comparative Examples 1 to 5 were measured in terms of contact angle θ of water with their surfaces.

The contact angle (θ) was measured based on the sessile drop method (half-angle fitting method) defined in JIS R 3257:1999. Specifically, the contact angle θ was measured by placing each glass member horizontally with the principal surface facing up, putting a drop of 2 μL of pure water on the principal surface, and taking a photograph of the water drop edge-on with a digital scope (product name: “VHX-500F” manufactured by Keyence Corporation).

### [Measurement of Surface Roughness]

Next, the principal surfaces of the glass members in Examples 1 to 26 and Comparative Examples 1 to 5 were measured in terms of surface roughness parameters (the mean widths RSm1 and RSm2 of elements, the arithmetical mean heights Sa1 and Sa2, the ratio between the mean height Rc1 of elements and the mean width RSm1 of elements (Rc1/RSm1), and the skewness Ssk). The measurements of the surface roughness parameters were made as to each of the principal surfaces with unevenness formed thereon. These measurements were made with an atom force microscope (AFM) or a white-light interference microscope.

Using as the atom force microscope (AFM) an atom force microscope (trade name: Dimension Icon (SPM unit) and Nano Scope V (controller unit), manufactured by Bruker Corporation), the measurements were conducted based on JIS B 0601:2013 and ISO 25178.

Furthermore, the measurements were made under measurement conditions where, using the tapping mode, the scan rate and the number of data sets acquired reached 1 Hz and 512×512, respectively, in a 5 μm×5 μm measurement area. Analysis was performed in a state where the cutoff value of a high-pass filter λc was set at 2.5 μm.

On the other hand, the white-light interference microscope used in measurements was a white-light interference microscope (product number: “NewView 7300”, manufactured by Zygo Corporation) and the measurements were conducted based on JIS B 0601:2013 and ISO 25178. The measurements for Examples 1 to 26 and Comparative Examples 1 to 5 were made under measurement conditions where, using a 50-power objective lens and a 1-power zoom lens, the number of integrations reached ten in a 140 μm×105 μm measurement area. After the gradients of the plane were removed by the least-square method, analysis was performed in a state where the cutoff value of a low-pass filter λc was set at 0.80 μm. The measurements for Comparative Example 5 were made under measurement conditions where, using a 50-power objective lens and a 1-power zoom lens, the measurement area was shifted in area units of 140 μm×105 μm and the final measurement area reached a total of 1000 μm×720 μm.

### [Measurement of Haze]

Next, the glass members in Examples 1 to 26 and Comparative Examples 1 to 5 were measured in terms of haze. The hazes were measured with a ultraviolet-visible-near infrared spectrophotometer (UV-670) manufactured by Shimadzu Corporation and based on JIS K 7361-1-1997.

The results are shown in Tables 3 and 4 below.

TABLE 3

| | | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Sa1 | [nm] | 10.6 | 10.6 | 10.0 | 8.3 | 9.6 | 11.3 | 9.6 | 9.9 | 10.5 | 10.5 | 9.4 | 10.3 | 3.6 | 21.0 |
| Ssk | | −0.8 | −0.9 | −0.9 | −1.1 | −0.9 | −0.6 | −0.5 | −0.4 | −0.6 | −0.6 | −0.6 | −0.7 | −1.6 | −0.6 |
| RSm1 | [nm] | 222.7 | 220.5 | 199.1 | 187.2 | 210.0 | 185.4 | 205.2 | 169.0 | 201.3 | 178.4 | 149.3 | 177.3 | 143.3 | 267.4 |
| Rc1 | [nm] | 29.2 | 21.2 | 22.7 | 22.7 | 21.8 | 18.5 | 23.4 | 23.5 | 24.6 | 21.3 | 25.5 | 26.4 | 9.8 | 35.3 |
| Rc1/ | | 0.13 | 0.10 | 0.11 | 0.12 | 0.10 | 0.10 | 0.11 | 0.14 | 0.12 | 0.12 | 0.17 | 0.15 | 0.07 | 0.13 |
| Rsm1 | | | | | | | | | | | | | | | |
| Sa2 | [nm] | 120.8 | 50.2 | 35.8 | 13.8 | 49.4 | 20.4 | 19.2 | 208.4 | 77.4 | 57.8 | 149.6 | 230.3 | 48.3 | 47.9 |
| RSm2 | [μm] | 13.1 | 9.5 | 6.2 | 9.4 | 25.5 | 10.3 | 4.1 | 13.1 | 15.7 | 18.9 | 21.0 | 23.0 | 25.7 | 24.9 |
| Contact | [°] | 97 | 99 | 101 | 100 | 98 | 101 | 99 | 99 | 99 | 102 | 95 | 100 | 95 | 97 |
| Angle | | | | | | | | | | | | | | | |
| Haze | [%] | 30.9 | 8.1 | 7.7 | 1.3 | 2.3 | 3.4 | 10.0 | 49.8 | 11.3 | 6.9 | 18.3 | 32.2 | 1.4 | 2.9 |

TABLE 4

| | | Ex. | Ex. | Ex. | Ex. | Ex. | Ex. | Ex. | Ex. | Ex. |
|---|---|---|---|---|---|---|---|---|---|---|
| | | 15 | 16 | 17 | 18 | 19 | 20 | 21 | 22 | 23 |
| Sa1 | [nm] | 13.1 | 14.0 | 14.8 | 13.1 | 14.9 | 15.3 | 13.9 | 17.8 | 16.0 |
| Ssk | | −0.5 | −0.5 | −0.4 | −0.6 | −0.5 | −0.4 | −0.2 | −0.2 | −0.5 |
| RSm1 | [nm] | 210.0 | 212.3 | 272.8 | 215.0 | 220.5 | 243.2 | 252.2 | 220.9 | 247.6 |
| Rc1 | [nm] | 34.5 | 28.9 | 41.8 | 38.2 | 33.4 | 35.1 | 36.8 | 35.1 | 41.0 |
| Rc1/Rsm1 | | 0.16 | 0.14 | 0.15 | 0.18 | 0.15 | 0.14 | 0.15 | 0.16 | 0.17 |
| Sa2 | [nm] | 47.8 | 80.3 | 128.6 | 55.8 | 68.7 | 175.6 | 377.7 | 638.7 | 603.4 |
| RSm2 | [μm] | 9.2 | 9.3 | 9.0 | 16.5 | 18.4 | 20.0 | 21.6 | 14.2 | 40.7 |
| Contact | [°] | 107 | 104 | 106 | 111 | 108 | 101 | 100 | 102 | 106 |
| Angle | | | | | | | | | | |
| Haze | [%] | 6.1 | 14.7 | 34.8 | 5.4 | 8.6 | 34.2 | 55.6 | 85.6 | 24.7 |

| | | | | | Comp. | Comp. | Comp. | Comp. | Comp. |
|---|---|---|---|---|---|---|---|---|---|
| | | Ex. | Ex. | Ex. | Ex. | Ex. | Ex. | Ex. | Ex. |
| | | 24 | 25 | 26 | 1 | 2 | 3 | 4 | 5 |
| Sa1 | [nm] | 13.5 | 13.2 | 35.1 | 0.1 | 0.4 | 0.4 | 10.4 | 6.6 |
| Ssk | | −0.4 | −0.4 | −0.3 | 0.0 | 0.0 | 0.0 | −0.7 | −0.8 |
| RSm1 | [nm] | 272.8 | 275.3 | 374.9 | 60.0 | 68.6 | 65.9 | 189.8 | 217.1 |
| Rc1 | [nm] | 38.7 | 37.4 | 51.9 | 0.3 | 0.9 | 0.9 | 26.4 | 15.4 |
| Rc1/Rsm1 | | 0.14 | 0.14 | 0.14 | 0.01 | 0.01 | 0.01 | 0.14 | 0.07 |
| Sa2 | [nm] | 609.8 | 1075.9 | 183.4 | 0.1 | 14.0 | 50.1 | 2.7 | 20.5 |
| RSm2 | [μm] | 51.4 | 36.3 | 19.4 | 2.5 | 9.7 | 25.2 | 2.9 | 500.0 |
| Contact | [°] | 103 | 105 | 108.0 | 14 | 47 | 43 | 80 | 75 |
| Angle | | | | | | | | | |
| Haze | [%] | 60.7 | 80.6 | 70.4 | 0.1 | 0.9 | 1.9 | 1.0 | 1.4 |

As shown in Tables 3 and 4, the glass members in Examples 1 to 26 showed a contact angle of 95° to 111° and were therefore confirmed to have excellent water repellency.

On the other hand, the glass members in Comparative Examples 1 to 5 showed a contact angle of 14° to 80° and therefore poor results indicating hydrophilicity.

The parameters RSm1 in Examples 1 to 26 were within a range of 143.3 nm to 374.9 nm. Furthermore, it was confirmed that the parameter RSm1 has a tendency to increase with increasing air pressure in the second wet blasting processing.

The parameters RSm2 in Examples 1 to 26 were within a range of 4.1 μm to 51.4 μm. Furthermore, it was confirmed that the parameter RSm2 has a tendency to increase as the average particle diameter of abrasive particles and the air pressure in the first wet blasting processing increase. In addition, it was confirmed that the parameter RSm2 has a tendency to increase with increasing etching processing time.

On the other hand, the parameters RSm1 in Comparative Example 1 not subjected to the series of processing was 60.0 nm, and RSm2 was 2.5 μm. Therefore, the parameters RSm1 and RSm2 in Comparative Example 1 not subjected to the series of processing were smaller than those in each of Examples 1 to 26.

The parameters RSm1 in Comparative Examples 2 and 3 subjected only to the chemical etching processing were 65.9 nm to 68.6 nm. The parameters RSm2 in Comparative Examples 2 and 3 were 9.7 μm to 25.2 μm. Therefore, the parameters RSm1 in Comparative Examples 2 and 3 were smaller than that in each of Examples 1 to 26.

The parameters RSm1 in Comparative Example 4 subjected only to the wet blasting processing was 189.8 nm, and RSm2 was 2.9 μm. Therefore, the parameter RSm2 in Comparative Example 4 was smaller than that in each of Examples. The parameters RSm1 in Comparative Example 5 was 217.1 nm, and RSm2 was 500.0 μm. Therefore, the parameter RSm2 in Comparative Example 5 was larger than that in each of Examples.

The parameters Sa1 in Examples 1 to 26 were within a range of 3.6 nm to 35.1 nm. It was confirmed that the parameter Sa1 has a tendency to increase as the air pressure and the average particle diameter of abrasive particles in the second wet blasting processing increase.

On the other hand, the parameters Sa1 in Comparative Example 1 not subjected to the series of processing and Comparative Examples 2 and 3 each subjected only to the chemical etching processing were 0.1 nm to 0.4 nm, which were smaller than that in each of Examples.

The parameters Sa2 in Examples 1 to 26 were within a range of 13.8 nm to 1075.9 nm. It was confirmed that the parameter Sa2 has a tendency to decrease as the average particle diameter and the processing air pressure in the first wet blasting processing decrease, the etching processing time increases, and the concentration of sulfuric acid in the etching liquid increases.

On the other hand, the parameter Sa2 in Comparative Example 1 not subjected to the series of processing was 0.1 nm, which was smaller than that in each of Examples.

The parameters Ssk in Examples 1 to 26 were within a range of −0.2 to −1.6.

On the other hand, the parameters Ssk in Comparative Example 1 not subjected to the series of processing and Comparative Examples 2 and 3 subjected only to the chemical etching processing were 0.0.

The ratios Rc1/RSm1 in Examples 1 to 26 were within a range of 0.07 to 0.18.

On the other hand, the ratios Rc1/RSm1 in Comparative Example 1 not subjected to the series of processing and Comparative Examples 2 and 3 subjected only to the chemical etching processing were 0.01, which was smaller than that in each of Examples.

It was confirmed from the above that the water repellency of the glass member can be increased by controlling the parameters related to roughness curves of the surface of the glass member.

Particularly, it was confirmed that, in Examples 1 to 26 in which the mean width RSm1 of roughness profile elements is not less than 70 nm and not more than 800 nm and the mean width RSm2 of roughness profile elements is not less than 3.0 μm and not more than 100.0 μm, the water repellency of the surface can be increased.

As shown in Tables 3 and 4, the haze has a tendency to increase as the parameter Sa2 increases. It can be considered that a glass member having a haze meeting desired properties or purposes can be obtained by controlling the parameter Sa2.

### REFERENCE SIGNS LIST

1, 21 . . . water-repellent glass member
1a, 1b . . . first, second principal surface
21a, 22a . . . principal surface
22 . . . glass member body
23 . . . functional film

1: A water-repellent glass member having a surface with unevenness, wherein
when a cutoff value of a high-pass filter λc in a 5 μm×5 μm area of the surface with unevenness is 2.5 μm, a mean width RSm1 of roughness profile elements is not less than 70 nm and not more than 800 nm, and
when a cutoff value of a low-pass filter λs in a 140 μm×105 μm area of the surface with unevenness is 0.80 μm, a mean width RSm2 of roughness profile elements is not less than 3.0 μm and not more than 100.0 μm.

2: The water-repellent glass member according to claim 1, wherein when the cutoff value of the high-pass filter λc in the 5 μm×5 μm area of the surface with unevenness is 2.5 μm, an arithmetical mean height Sa1 is not less than 1 nm and not more than 50 nm.

3: The water-repellent glass member according to claim 1, wherein when the cutoff value of the low-pass filter λs in the 140 μm×105 μm area of the surface with unevenness is 0.80 μm, an arithmetical mean height Sa2 is not less than 1 nm and not more than 1500 nm.

4: The water-repellent glass member according to claim 1, wherein when the cutoff value of the high-pass filter λc in the 5 μm×5 μm area of the surface with unevenness is 2.5 μm, a skewness Ssk is −0.1 or less.

5: The water-repellent glass member according to claim 1, wherein when the cutoff value of the high-pass filter λc in the 5 μm×5 μm area of the surface with unevenness is 2.5 μm, a ratio between a mean height Rc1 and the mean width RSm1 of roughness profile elements (Rc1/RSm1) is not less than 0.02 and not more than 1.00.

6: The water-repellent glass member according to claim 1, wherein a contact angle of water with the surface with unevenness of the water-repellent glass member is 90° or greater.

7: The water-repellent glass member according to claim 1, comprising:
a glass member body; and
a water-repellent film provided on a principal surface of the glass member body.

8: The water-repellent glass member according to claim 1, comprising:
a glass member body; and
an optically functional film provided on a principal surface of the glass member body.

9: The water-repellent glass member according to claim 8, wherein the optically functional film is an antireflection film or a reflective film.

10: A method for manufacturing the water-repellent glass member according to claim 1, the method comprising the steps of:
subjecting a surface of the glass member to chemical etching processing; and
subjecting the surface of the glass member, after being subjected to the chemical etching processing, to wet blasting processing.

11: A lens member comprising the water-repellent glass member according to claim 1.

12: A cover member comprising the water-repellent glass member according to claim 1.

13: A window panel member comprising the water-repellent glass member according to claim 1.
